(19) United States
(12) Patent Application Publication
(10) Pub. No.: US 2026/0317124 A1
(43) Pub. Date: Oct. 15, 2026

(54) OVERLOAD TESTING SYSTEMS

(71) Applicant: ALIMAK GROUP MANAGEMENT AB, STOCKHOLM (SE)

(72) Inventors: Raul CORRAL DOBATO, LA MUELA (ES); Olga LACÁMARA DOMÍNGUEZ, LA MUELA (ES)

(21) Appl. No.: 19/491,512

(22) PCT Filed: Jun. 14, 2024
(86) PCT No.: PCT/EP2024/066646

§ 371 Date: Dec. 9, 2025

(30) Foreign Application Priority Data
Jun. 16, 2023 (EP) 23382606.4

(51) Int. Cl. B66B 5/00; B66B 5/14

(52) U.S. Cl. CPC B66B 5/0093; B66B 5/14

(57) ABSTRACT

In a first aspect, an overload testing system for testing an overload mechanism of a traction system is provided. The overload testing system comprises a lower frame; an upper frame configured to be coupled with a traction wire, wherein the upper frame is slidably connected to the lower frame; a pressure element arranged between the upper frame and the lower frame to move the lower frame relative to the upper frame; and wherein the lower frame and the upper frame comprise a channel to receive the traction wire. In a further aspect, a method for testing an overload mechanism of a traction system is provided. The method comprises positioning a lower frame to rest on the traction system; coupling an upper frame with the traction wire, wherein the lower frame is slidably connected to the upper frame; and applying a predetermined pressure to move the lower frame relative to the upper frame so as to increase a traction exercised on the traction wire.

The present application claims the benefit and priority of EP23382606.4 filed on Jun. 16, 2023.

The present disclosure relates to overload testing systems for testing overload mechanisms of traction systems of lifting equipment. In addition, the present disclosure relates to methods for testing overload mechanisms of traction systems of lifting equipment and to methods for setting load thresholds of overload mechanisms of traction systems of lifting equipment.

### BACKGROUND

Lifting equipment or lift systems may be arranged at structures for transporting up and down goods or users. Service lifting equipment or service lift systems are used for lifting and lowering technical or maintenance staff. These service lifts or service elevators may be provided in e.g. wind turbines, construction sites, cranes, silos, chimneys and in different sorts of towers. Building maintenance units for performing maintenance operations in high buildings or structures are also examples of service lift systems.

Hoists are often used in the form of elevator-like structures where a load carrier structure for the transportation of people and/or equipment is hoisted up and/or down within the building structure, e.g. within a wind turbine tower. For example, the load carrier structure may be a lift platform or a lift cabin. Service lift systems or service lifting equipment may include a load carrier structure suspended within a hoistway or lift path by wire or wire ropes. The load carrier structure may be a lift cabin or carrier or a lift platform such as in the building maintenance units.

The service lifts or service lifting equipment may comprise a traction system for lifting and lowering the load carrier structure. In some examples, the driving system may be a traction system involving the use of a traction wire or a traction chain. The traction system may be mounted on or attached to the load carrier structure. The traction system may comprise a housing including a driving or a traction mechanism, e.g. a motor driving a traction or driving sheave. The motor may typically be an electrical motor, although in principle other motors could be used. The driving mechanism engages a traction wire or a traction chain for lifting and lowering the load carrier structure. The load carrier structure may therefore be supported by the traction wire or by the traction chain.

The use of such service lifts may require compliance with standards and safety regulations. For example, some standards regulate the rated load capacity of the load carrier structure, e.g. a lift cabin or a lift platform. Load sensors or overload mechanisms may be employed to prevent using the load carrier structure when an excessive load or overload is detected, i.e. loads exceeding a load threshold. The load threshold may be defined for a specific application or for a specific type of load sensor or overload mechanism.

In some examples, an overload mechanism may be mounted within the traction system. The overload mechanism may detect an excessive load by sensing the degree of stretching or the traction applied to the traction wire. Once an overload is detected, a warning signal is triggered to warn that the load supported by the load carrier structure is greater than the load threshold of the overload mechanism. The load threshold is associated with the rated load capacity of the lift system. For example, the load threshold of the overload mechanism is generally related to the rated load capacity or to the rated load capacity multiplied by a safety factor.

However, these overload mechanisms may wear out or go out of adjustment from time to time. The load threshold of the overload mechanism may consequently vary over time. This may lead to not triggering the warning signal after reaching an excessive load. The load carrier structure may thus not be designed to withstand this excessive load. Consequently, the overload mechanisms must be periodically inspected and adjusted to ensure the load carrier structure is not carrying an excessive load.

The overload mechanisms may be tested by placing several weights inside the load carrier structure so as to stretch the traction wire. When the overload mechanism detects an excessive load, a warning signal is output. This indicates the load of the load carrier structure is greater than the load threshold of the overload mechanism. However, this method implies that the staff must carry several weights, e.g. heavy blocks, to the lift system. This may be complex in some lift systems. For example, transporting weights to some wind turbines, e.g. offshore wind turbines, may be time-consuming and labor-intensive. In addition, manipulating the weights may involve safety risks. Furthermore, the staff must be inside the load carrier structure, e.g. the lift cabin or lift carrier to test the overload mechanism. This may involve high safety risks.

In other examples, the load carrier structure may be pulled from below to simulate a load. However, this requires mounting a pulling system below the load carrier structure. This may represent a safety risk. Furthermore, mounting the pulling system below the load carrier structure may be time-consuming.

The present disclosure provides examples of systems and methods that at least partially resolve some of the aforementioned disadvantages.

### SUMMARY

In a first aspect, an overload testing system for testing an overload mechanism of a traction system of a lifting equipment is provided. The lifting equipment may comprise a load carrier structure, a traction wire, and a traction system arranged at the load carrier structure for driving the load carrier structure along a lift path. The traction system may comprise a traction mechanism that engages the traction wire to lift and lower the load carrier structure. The traction system may further comprise an overload mechanism to prevent movement of the load carrier structure if the load of the load carrier structure is greater than a load threshold. The overload mechanism may detect an excessive load, i.e. load of the load carrier structure greater than a load threshold, by sensing or monitoring traction or the degree of stretching applied to the traction wire.

Lifting equipment and lift system are used herein interchangeably. The lifting equipment may be a service lift system or a service lifting equipment. For example, the service lift system may be a building maintenance unit and/or installed within a slender structure, e.g. within a wind turbine tower.

The load carrier structure is configured to support and transport people and/or equipment along a lift path. The load carrier structure may be hoisted up and/or down to transport people and/or equipment within a structure. Examples of load carrier structures may be lift cabins, lift cages or lift platforms. Lift cages and lift platforms may be used in building maintenance units.

The overload testing system comprises a lower frame and an upper frame configured to be coupled with a traction wire of the lifting equipment. The upper frame is slidably connected to the lower frame. The lower frame and the upper frame comprise a channel to receive the traction wire. The overload testing system further comprises a pressure element arranged between the upper frame and the lower frame to move the lower frame relative to the upper frame. The lower frame is configured to rest on the traction system of the lifting equipment.

When the upper frame is coupled with the traction wire and the lower frame is supported by the traction system, an upwards movement of the upper frame is prevented. Accordingly, a relative movement between the upper frame and the lower frame causes a downward pressure towards the load carrier structure which causes an increase in the traction of the traction wire. The degree of stretching is thus increased. The stretching of the traction wire may thus be sensed by the overload mechanism. The overload mechanism may detect an excessive stretching of the traction wire that implies an excessive load. This may be used for testing the functioning of the overload mechanism. For example, when the pressure exerted by the pressure element is greater than the theoretical load threshold of the overload mechanism, and the traction generated in the traction wire does not trigger a warning signal of the overload mechanism, this may be indicative of a malfunctioning of the overload mechanism.

According to this aspect, testing the overload mechanism is simplified and time for testing the overload mechanism is considerably reduced. Furthermore, the overload testing system may be arranged at or on the load carrier structure. The overload testing system may thus be mounted from a landing platform. Installation operations below the load carrier structure are thus avoided. Moreover, carrying and transporting heavy weights are avoided. Consequently, safety risks are reduced. Additionally, the pressure provided by the pressure element may be accurately controlled. As a result, the stretch of the traction wire may also be accurately controlled. Precision in testing the overload mechanism may thus be increased.

Furthermore, as the lower frame may be supported by the traction system, the lower frame may rest on a resistant structure as the traction system, e.g. traction or hoist mechanism. High pressure may thus be exercised by the lower frame toward the load carrier structure without damaging the load carrier structure.

In a further aspect, a method for testing an overload mechanism of a traction system of an lifting equipment is provided. The lifting equipment may be according to the lifting equipment of the previous aspect. The method comprises positioning a lower frame of an overload testing system to rest on the traction system, and coupling an upper frame of the overload testing system with the traction wire. The lower frame is slidably connected to the upper frame. Then, a predetermined pressure is applied to move the lower frame relative to the upper frame so as to increase a traction exercised on the traction wire.

The method may employ an overload testing system according to any of the examples herein. The predetermined pressure generates a predetermined load on the traction wire. This predetermined load may be a load greater than the expected rated load capacity or the expected rated load capacity multiplied by a safety factor. Accordingly, if the overload mechanism detects an excessive stretching of the traction wire before reaching the predetermined load, this may indicate that the overload mechanism is not correctly calibrated. In this case, the load carrier structure could still withstand greater loads, so the load threshold of the overload mechanism can be adjusted to increase its value.

Advantages derived from this aspect may be similar to those mentioned regarding the first aspect.

In yet a further aspect, a method for setting a load threshold of an overload mechanism of a traction system of a lifting equipment is provided. The lifting equipment may be according to the lifting equipment of the previous aspects. The method comprises testing the overload mechanism according to any of the examples herein, and adjusting the overload mechanism to set the load threshold corresponding to the predetermined pressure applied to the overload testing system.

According to this aspect, the load threshold of the overload mechanism may be accurately set. The overload mechanism may thus be calibrated to ensure that a warning signal is outputted when a load is greater than the predetermined load (load caused by the predetermined pressure). The overload mechanism may thus be precisely adjusted. The safety risk of using the load carrier structure with an incorrect calibration may thus be avoided.

### BRIEF DESCRIPTION OF THE DRAWINGS

Non-limiting examples of the present disclosure will be described in the following, with reference to the appended drawings, in which:

FIG. 1 schematically represents an lifting equipment according to an example of the present disclosure;

FIG. 2 represents a traction system according to an example of the present disclosure;

FIG. 3 represents a traction mechanism of the traction system of FIG. 2;

FIGS. 4A and 4B respectively represent an overload mechanism when the traction load is smaller than a load threshold and when the traction load is greater than the load threshold according to an example of the present disclosure;

FIG. 5 schematically represents an overload testing system mounted on an load carrier structure according to an example of the present disclosure;

FIGS. 6A and 6B respectively represent an overload testing system in an initial position and in an extending position according to an example of the present disclosure;

FIG. 7A and 7B are isometric views of an overload testing system according to an example of the present disclosure;

FIG. 8 is a cross-section view of the overload testing system of FIGS. 7A and 7B; and

FIG. 9 schematically represents a block diagram of a method for testing an overload mechanism of a traction system of an lifting equipment according to an example of the present disclosure.

### DETAILED DESCRIPTION OF EXAMPLES

In these figures, the same reference signs have been used to designate matching elements.

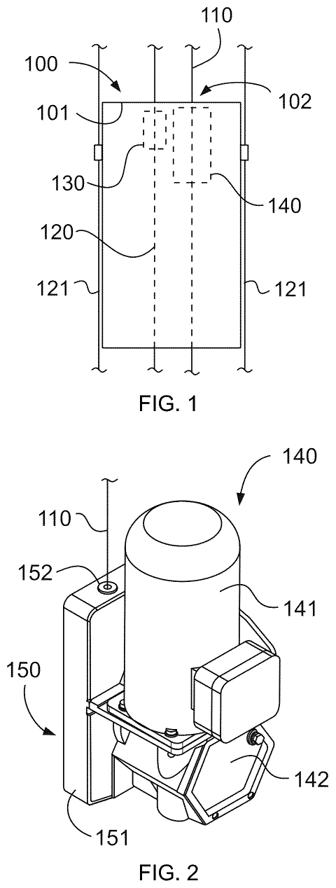

FIG. 1 schematically illustrates an lifting equipment having an load carrier structure that may be moved upwards and downwards along the lift path. The load carrier structure of this example is a lift cabin 100. In other examples, the load carrier structure may be a lift cage or a lift platform.

The lifting equipment of this example is guided through a pair of taut wire ropes 121 arranged along the lift path to guide the movement of the load carrier structure, in this example, the lift cabin 100. The taut wire ropes 121 are arranged at the lateral sides of the load carrier structure. The lifting equipment of this example is thus a wire-guided lift system. In other examples, the upwards and downwards movement of the load carrier structure may be guided by a structure, e.g. the lift system may be a ladder-guided lift system.

The lifting equipment of this example is a service lift system. In particular, the lift system of FIG. 1 is a service lifting system installed in a wind turbine tower. The wind turbine tower may thus comprise the lift system of this example. In other examples, the elevator system may be arranged in other slender structures or may be a building maintenance unit.

The lift system of this figure comprises a traction wire 110 that runs into the lift cabin or lift carrier 100 to pass through a traction system 140. The traction system 140 of this example is arranged inside the lift cabin 100. The traction system 140 may be mounted on a supporting structure of the load carrier structure, e.g. of the lift cabin 100. An aperture 102 formed at an upper wall 101 of the lift cabin 100 allows the traction wire 110 to enter the lift cabin 100.

In this figure, the lift system or lifting equipment further comprises a safety wire 120. The safety wire 120 passes through a fall arrest device 130 connected to the lift cabin 100. The fall arrest device 130 may comprise an overspeed detector and a blocking system for blocking the lift cabin 100 when an overspeed is detected by the overspeed detector. In this example, the fall arrest device 130 engages the safety wire 120; however, in other examples, the fall arrest device may directly engage the traction wire 110.

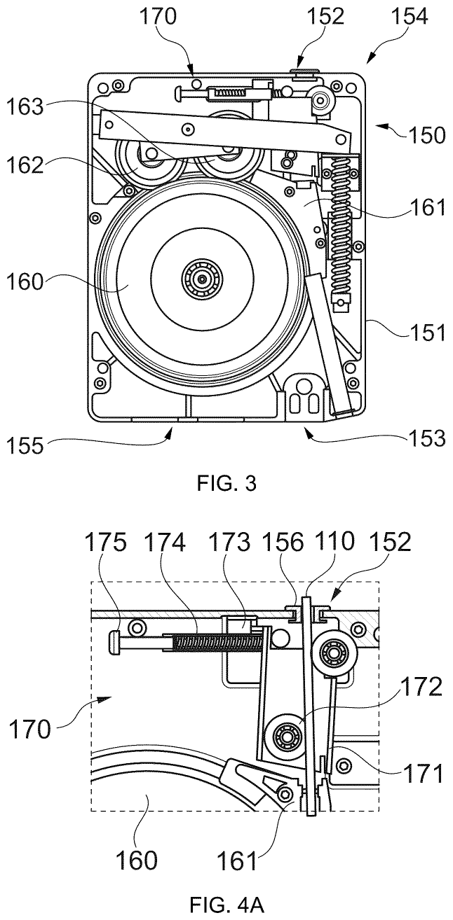

FIGS. 2 and 3 respectively represent a traction system and a traction mechanism of the lift system of FIG. 1. The traction system 140 comprises a traction hoist or traction mechanism 150 arranged within a housing 151. The housing 151 encloses the traction mechanism 150. The traction wire 110 enters the housing 151 through an entry hole 152 arranged at an upper side 154 and exits through an exit hole 153 arranged at the bottom side 155 of the housing 151. In this example, the traction wire 110 passes completely around a traction sheave 160 and then exits the traction mechanism 150 through the exit hole 153. In this example, a traction wire guide 161, a first pressure roller 162, and a second pressure roller 163 ensure that the traction wire 110 maintains contact with the traction sheave 160 along the entire perimeter of the traction sheave 160.

The traction system 140 of this example further comprises an electric motor 141 that drives the traction sheave 160 through a gear system 142 involving one or more stages. The rotation of the traction sheave 160 causes the climb or descent of the traction wire 110. The load carrier structure, e.g. the lift cabin 100 may thus be moved upwards or downwards. The traction system 140 may further comprise an electromagnetic brake that engages a rotating part of the traction system 140, e.g. a shaft of the motor 141, a gear or a shaft of the gear system 142 or the traction sheave 160. When power is supplied to the electromagnetic brake, the electromagnetic brake is released, and the traction sheave 160, may rotate causing a vertical movement of the load carrier structure. On the contrary, when no power is supplied to the electromagnetic brake, brake pads block the rotation of the traction sheave 160 preventing a vertical movement of the load carrier structure.

The traction system 140 of this example further comprises an overload mechanism 170. The overload mechanism 170 continuously measures the load supported by the load carrier structure, e.g. the lift cabin 100 or a lift platform. In this example, the overload mechanism 170 measures the degree of stretching of the traction wire 110. The traction of the traction wire 110 is thus continuously monitored by the overload mechanism 170. The overload mechanism 170 of this example is arranged within the housing 151 of the traction mechanism 150. The overload mechanism 170 of this example is between the entry hole 152 and the traction sheave 160.

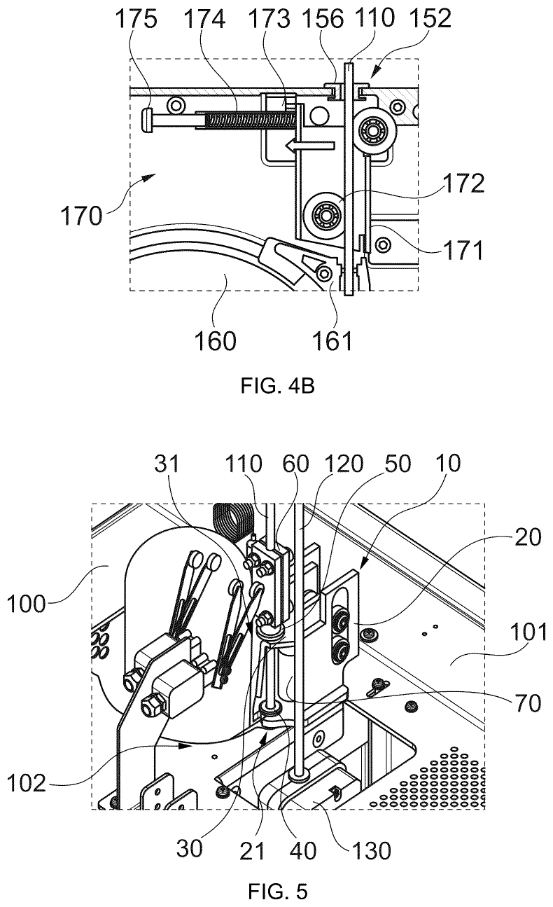

FIGS. 4A and 4B respectively represent an overload mechanism when the traction load is smaller than a load threshold and when the traction load is greater than the load threshold according to an example of the present disclosure. The overload mechanism 170 of these figures is arranged inside the traction mechanism 150. In these figures, the overload mechanism 170 is arranged between the entry hole 152 of the traction mechanism and the traction wire guide 161 around the traction sheave 160. The entry hole 152 of this example comprises an entry hole bushing 156 that defines the aperture of the entry hole 152. The overload mechanism 170 comprises a pivotable bracket 171 and a pivotable roller 172 that rotates towards an overload switch 173 when the traction of the traction wire 110 increases.

In FIG. 4A, the traction experienced by the traction wire 110 is lower than the load threshold set by the overload mechanism 170. When the traction of the traction wire 110 increases the bracket 171 rotates towards the overload switch 173. The stretching of the traction wire 110 is thus continuously monitored by the overload mechanism 170. As illustrated in FIG. 4B, when the stretch or the traction reaches the load threshold defined by the overload mechanism 170, the bracket 171 contacts the overload switch 173 and a warning signal may be outputted by the overload mechanism 170. In some examples, the movement of the load carrier structure may also be blocked when the overload switch 173 is contacted by the bracket 171.

The position of the overload switch 173 may be varied by the elongation of a spring 174 that may be adjusted through the screw 175. The screw 175 may be rotated with a suitable tool from outside the load carrier structure, e.g. outside the lift cabin 100. By varying the elongation of the spring 174, the load threshold defined by the overload mechanism 170 may be adjusted.

FIG. 5 schematically represents an overload testing system mounted on a load carrier structure according to an example of the present disclosure. The overload testing system 10 is mounted on the lift cabin 100; however, in other examples, the overload testing system 10 may be mounted inside the lift cabin 100, or in other types of load carrier structures. The lift system of this example may be according to any of the examples herein. The traction wire 110 passes through the upper wall 101 of the lift cabin 100 through the aperture 102 towards the traction system (not visible in FIG. 5). The traction system according to this example is arranged inside the lift cabin 100.

The lift system of this example further comprises a safety wire 120 that passes through a fall arrester device 130 arranged within the lift cabin 100.

The overload testing system 10 comprises a lower frame 20 and an upper frame 30. The upper frame 30 is slidably connected to the lower frame 20. The lower frame 20 and the upper frame 30 comprises a channel 21, 31 to receive the traction wire 110. The traction wire 110 thus runs along the upper channel 31 and the lower channel 21. The overload testing system 10 of this example further comprises an upper bushing 50 and a lower bushing 40. The upper bushing 50 and the lower bushing 40 surrounds the traction wire 110 and are respectively arranged inside the corresponding channel 31 and 21. The upper bushing 50 and the lower bushing 40 are thus configured to fit the corresponding channel 21, 31 and to receive the traction wire 110.

In this figure, the lower frame 20 rests on the traction system 140. The lower frame 20 is thus configured to rest or to be supported by the traction system 140. The lower frame 20 may be supported by the housing 151 of the traction mechanism 150, e.g. by an upper side 154 of the housing 151 of the traction mechanism 150. In some examples, the lower bushing 40 comprises an engaging portion to engage the traction system 140, e.g. the entry hole bushing 156 of the traction mechanism 150. Pressure from the lower frame 20 may thus be effectively transferred through the traction system 140, e.g. the traction mechanism 150, towards the lift cabin 100 without damaging the lift cabin 100.

The upper frame 30 of this figure is retained by a wire clamp 60 arranged above the upper frame 30. The wire clamp 60 of this example clamps the traction wire 110. Accordingly, the wire clamp 60 prevents an upwards movement of the upper frame 30. The upper frame is thus configured to be coupled with the traction wire 110. The upper bushing 50 may comprise an engaging portion to engage the wire clamp 60.

The overload testing system further comprises a pressure element 70 arranged between the upper frame 30 and the lower frame 20 to move the lower frame 20 relative to the upper frame 30. The pressure element 70 of this example is configured to extend from an initial position to an extending position. As the upwards movement of the upper frame 30 is blocked by the wire clamp 60, the extension of the pressure element 70 causes a downward movement of the lower frame 20 that pushes the lift cabin 100. The downward movement of the lift cabin 100 may be blocked by the electromagnetic brake of the traction mechanism 150. Accordingly, the pressure exercised by the pressure element 70 onto the lower frame 20 and the upper frame 30 causes the stretching of the traction wire 110. This increase in the traction of the traction wire 110 is monitored by the overload mechanism 170.

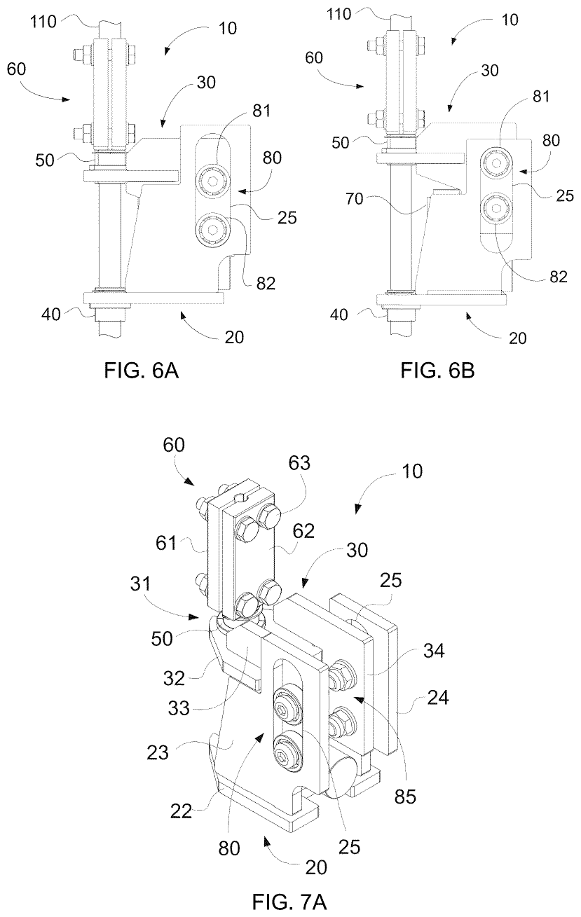

FIGS. 6A and 6B respectively represent an overload testing system in an initial position and in an extending position according to an example of the present disclosure. In FIG. 6A, the overload testing system 10 is in the initial position, wherein the pressure element 70 is not applying pressure against the upper frame 30 and the lower frame 20. In FIG. 6B, the pressure element 70 applies a pressure against the upper frame 30 and the lower frame 20. This pressure causes a movement of the lower frame 20 relative to the upper frame 30 and the stretch of the traction wire 110 running through holes made on the upper frame 30 and the lower frame 20.

In these figures, a lower bushing 40 surrounds the traction wire 110 and is arranged in the channel of the lower frame 20, whereas an upper bushing 50 also surrounds the traction wire 110 and is arranged in the channel of the upper frame 30. The lower bushing may rest on a traction system and the upper bushing is blocked by a wire clamp 60 clamped onto the traction wire 110. As the upwards movement of the upper frame 30 is restricted by the wire clamp 60, the relative movement caused by the pressing element provokes a downward movement of the lower frame 20, and consequently of the traction system and of the load carrier structure.

In this example, the pressure element 70 comprises a hydraulic cylinder. In other examples, other types of pressure elements may alternatively be used, e.g. pneumatic or mechanical pressure elements. The hydraulic cylinder may extend from a lower end connected to the lower frame 20 to an upper end connected to the upper frame 30. A distance between the lower end and the upper end may increase when a predetermined pressure is applied to the hydraulic cylinder. The hydraulic cylinder may thus extend when a predetermined pressure is applied. The upper frame 30 may thus be moved relative to the lower frame 20.

The hydraulic cylinder of this example is configured to be connected to a hydraulic pressure source. The pressure applied against the upper and lower frame may thus be controlled. This may allow for applying a predetermined pressure. The pressure source may provide a specific pressure. The pressure generated by the pressure source may be selected for generating a predetermined load on the traction wire, i.e. a specific degree of stretching on the traction wire 110. The predetermined load on the traction wire 110 generated by the predetermined pressure may be the rated load capacity multiplied by a safety factor.

In some examples, the pressure source may be a manual pump. The manual pump may be connected to the hydraulic cylinder through a hose. The manual pump may provide a specific pressure to the pressure element. When the manual pump is activated, oil is released from the manual pump to the pressure element.

In these figures, a first connection assembly 80 is connected to the upper frame 30 and slides through a slot 25 arranged at the lower frame 20. The first connection assembly 80 of these figures comprises an upper roller 81 and a lower roller 82. The upper roller 81 and the lower roller 82 are rotatably connected to the upper roller and may be moved upwards and downwards along the vertical slot 25. The relative movement between the upper frame 30 and the lower frame 20 is thus restricted by the slot 25.

Although not shown in these figures, the overload testing system may comprise a second connection assembly connected to another side of the upper frame 30 and slides through a slot arranged at another side of the lower frame 20.

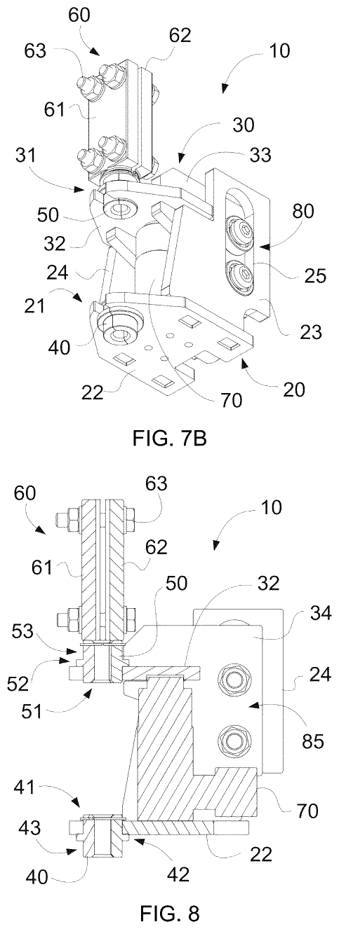

FIGS. 7A and 7B are isometric views of an overload testing system according to an example of the present disclosure and FIG. 8 is a cross-section view of the overload testing system of FIGS. 7A and 7B.

The overload testing system 10 of this example comprises a wire clamp 60 for clamping a traction wire (not shown in these figures). The wire clamp 60 is arranged above the upper frame 30 to restrict an upwards movement of the upper frame relative to the lower frame 20. The wire clamp 60 comprises a first clamp part 61 and a second clamp part 62 to surround the traction wire. A connector may be used to connect the first clamp part 61 to the second clamp part 62 to clamp the traction wire. In this example, a plurality of connectors 63 connect the first clamp part 61 and the second clamp part 62 to press the first clamp part 61 and second clamp part 62 to each other to clamp the traction wire between the first clamp part 61 and the second clamp part 62. The wire clamp 60 may thus be mounted at any desired position of the traction wire. The connector may comprise a screw and nut tightened at a specific pressure to ensure a fixed connection of the wire clamp 60 relative to the traction wire.

In these figures, an upper bushing 50 is arranged below the wire clamp 60 to couple the upper frame 30 with the traction wire in a fixed position. In these figures, the upper bushing 50 comprises a first bushing part and a second bushing part to surround the traction wire. The bushing parts may be joined together to wrap the traction wire. For example, an annular pressure element may be placed to surround and press the bushing parts. This configuration allows for mounting the upper bushing 50 in existing traction wires.

The upper bushing 50 of these figures comprises an insertion portion 51 configured to be inserted into the channel 31 of the upper frame 30. The outer diameter of the insertion portion 51 is smaller than the diameter of the channel 31. The insertion portion 51 may thus fit the channel 31 of the upper frame 30. The upper bushing of this example further comprises a stopper portion 52 to stop the entire insertion of the upper bushing into the channel 31. The stopper portion 52 of these figures comprises an outer diameter smaller than the diameter of the channel 31 so as to stop the insertion of the stopper portion 52 into the channel 31.

Furthermore, the upper bushing 50 of this example comprises an engaging portion 53 to engage the wire clamp 60. The uppermost region of the engaging portion 53 may be received in the channel defined by the wire clamp 60. The stopper portion 52 is arranged between the engaging portion 53 and the insertion portion 51.

The upper bushing 50 engaging the wire clamp 60 of this example allows for fixedly connecting the upper frame 30 of the overload testing system 10 to the traction wire. Similar to the upper bushing 50, the lower bushing 40 of these figures comprises a first bushing part and a second bushing part to wrap the traction wire. The lower bushing 40 of this example comprises an insertion portion 41, a stopper portion 42, and an engaging portion 43. The insertion portion 41 is configured to fit the channel 21 of the lower frame 20. The outer diameter of the insertion portion 41 is smaller than the inner diameter of the channel 21 of the lower frame so as to be inserted into the channel 21. The stopper portion 42 comprises an outer diameter greater than the inner diameter of the channel 21 to prevent the insertion of the stopper portion 42 into the channel 21. The engaging portion 43 may engage the traction system, e.g. may fit the entry hole of a traction mechanism.

The lower frame 20 of this example comprises a base 22 comprising the channel 21. The lower frame 20 further comprises a first side wall 23 and a second side wall 24, The side walls 23, 24 extend perpendicular from the base 22. The lower frame 20 may thus comprise a substantially U-shape. The side walls 23, 24 may be welded to the base 22. The side walls 23,24 of these figures comprise a vertical slot 25 to guide the upwards and downwards movement of the upper frame 30 relative to the lower frame 20.

In this example, the upper frame 30 comprises a base 32 comprising the channel 31 and two side walls 33, 34 that extend perpendicular from the base 32. The upper frame 30 thus comprises a substantial U-shape. The base 32 is supported by a flat portion of the side walls 23,24 of the lower frame 20. The first side wall 33 and the second side wall 34 of the upper frame 30 extend towards the base 22 of the lower frame 20.

In this example, the side walls 33, 34 of the upper frame 30 are arranged between the side walls 23, 24 of the lower frame 20. The upper frame 30 may thus substantially engage the lower frame 20. In other examples, the side walls 23, 24 of the lower frame 20 may be arranged between the side walls 33, 34 of the upper frame 30. The pressure element 70 of this example is arranged between the side walls 33, 34 of the upper frame 30 and between the side walls 23, 24 of the lower frame 20.

The pressure element 70 of this example is a hydraulic cylinder. The hydraulic cylinder comprises an upper end connected to the base 32 of the upper frame 30 and a lower end connected to the base 22 of the lower frame 20. The extension and compression of the pressure element 70 thus move the lower frame 20 relative to the upper frame 30.

In this example, the overload testing system 10 comprises a first connection assembly 80 slidably connecting the first side walls 23, 33 and a second connection assembly 85 slidably connecting the second side walls 24, 34. The first connection assembly 80 is rotatably connected to the first side wall 33 of the upper frame 30 and slidably connected to the first side wall 23 of the lower frame 20 through the slot 25. The second connection assembly 85 is rotatably connected to the second side wall 34 of the upper frame 30 and slidably connected to the second side wall 24 of the lower frame 20 through the slot 25 of the second side wall 24.

The connection assemblies 80, 85 of these figures comprise an upper and a lower roller. The rollers are rotatably connected to the side walls 33, 34 of the upper frame 30. These rollers may be moved through the slots of the side walls 23, 24 of the lower frame 20.

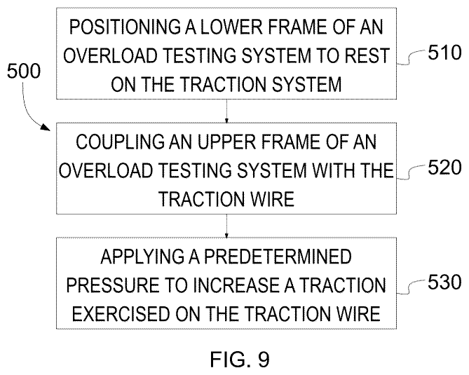

FIG. 9 schematically represents a block diagram of a method for testing an overload mechanism of a traction system of a lift system according to an example of the present disclosure. The overload mechanism 170, the traction system 140 and the lift system may be according to any of the examples herein. The method 500 may employ using an overload testing system 10 according to any of the examples herein.

The method 500 comprises positioning a lower frame 20 of an overload testing system 10 to rest on the traction system 140, as represented at block 510. The lower frame 20 may be arranged on the entry hole 152 of the traction mechanism 150 of the traction system 140.

In some examples, positioning the lower frame 20 to rest on the traction system 140 may comprise placing a lower bushing 40 to rest on the traction system and inserting the traction wire 110 into the lower bushing 40. The traction wire 110 may be received by the lower bushing 40 by placing a first bushing part and a second bushing part around the traction wire 110. These bushing parts may then be connected to surround the traction wire 110.

An engaging portion 43 of the lower bushing 40 may rest on the entry hole bushing 156 of the traction mechanism 150. The engaging portion 43 may be inserted into the entry hole bushing 156. The bushing parts may be placed around the traction wire 110 and, then may slide through the traction wire to for engaging the traction mechanism, e.g. the entry hole 152 or the entry hole bushing 156. A portion of the lower bushing 40, e.g. an insertion portion 41, may then be inserted into the channel 21 of the lower frame 20. The insertion may be stopped by the stopper portion 42 that may contact a lower surface of the base 22 of the lower frame 20. The traction wire 110 and the insertion portion 41 of the lower bushing 40 may thus be received by the channel 21.

The method 500 additionally comprises coupling an upper frame 30 of the overload testing system 10 with the traction wire 110, as represented at block 520. The lower frame 20 is slidably connected to the upper frame 30. The upper 30 and lower frame 20 may be according to any of the examples herein.

The upper frame 30 may be connected to the traction wire 110 when the lower frame 20 rests on the traction system 140. In some examples, coupling the upper frame 30 with the traction wire 110 comprises placing an upper bushing 50 above the upper frame 30 and inserting the traction wire into the upper bushing 50. The traction wire may be inserted into the upper bushing may comprise placing a first bushing part and a second bushing around the traction wire 110. The bushing parts may thus surround the traction wire 110.

Coupling the upper frame 30 with the traction wire 110 may comprise inserting the upper bushing 50 into the channel 31 of the upper frame 30. The upper bushing 50 surrounding the traction wire 110 may slide through the traction wire towards the channel 31. An insertion portion 51 of the upper bushing 50 may be inserted into the channel 31. The insertion of the upper bushing 50 may be stopped by the stopper portion 52 of the upper bushing 50. The upper bushing 50 surrounding the traction wire 110 is thus accommodated in the channel 31.

In some examples, coupling the upper frame 30 with the traction wire 110 comprises placing a wire clamp 60 to rest on the upper bushing 50. The traction wire 110 may thus be clamped with wire clamp 60 to prevent an upwards movement of the upper frame 30. The upper frame 30 may thus be fixedly connected to the traction wire 110. In some examples, clamping the wire clamp 60 onto the traction wire 110 may comprise connecting a first clamping part 61 to a second clamping part 62 to press the traction wire 110 therebetween. The wire clamp 60 may be placed to rest on the upper bushing 50 arranged inside the channel 31 when the lower bushing 40 is arranged on the channel 21 and rest on the traction system 140.

As represented at block 530, the method 500 further comprises applying a predetermined pressure to move the lower frame 20 relative to the upper frame 30 so as to increase a traction exercised on the traction wire 110. The predetermined pressure is selected to generate a predetermined load on the traction wire 110. This predetermined load may be the rated load capacity, or the rated load capacity multiplied by a safety factor. The predetermined load is the load that should theoretically trigger the action of the overload mechanism, or in other words, the predetermined load should theoretically correspond to the load threshold set by the overload mechanism. In elevators arranged in wind turbines, this predetermined load may be the rated load capacity of the lift system multiplied by a safety factor corresponding to 1,25.

In some examples, when the pressure element is a hydraulic cylinder, the method may further comprise connecting the hydraulic cylinder to a hydraulic pressure source. The hydraulic pressure source may be a manual pump. The hydraulic pressure may then be activated, e.g. an operator may release oil by acting on the manual pump, to provide the predetermined pressure to the hydraulic cylinder. The manual pump may be connected to the hydraulic cylinder and may provide a dynamic pressure to the pressure element. The traction load applied onto the traction wire may thus be gradually increased. This allows for a precise increase in the load of the traction wire. The overload mechanism may thus be precisely tested.

The method for testing an overload mechanism may be used for calibrating the overload mechanism. For example, when the threshold load is greater than the predetermined load, the threshold load of the overload mechanism may be reduced. And, when the predetermined load is greater than the threshold load, the threshold load may be increased.

A method for setting a load threshold of an overload mechanism is provided. The overload mechanism 170, the traction system 140 and the lift system may be according to any of the examples herein. The method for setting the load threshold comprises testing the overload mechanism 170 according to any of the examples herein; and adjusting the overload mechanism 170 to set the load threshold corresponding to the predetermined pressure applied to the overload testing system.

The predetermined pressure may be selected for generating a predetermined load on the traction wire 110. The predetermined load may be the maximum lifting capacity or the maximum lifting capacity multiplied by a safety factor. The predetermined load is thus the theoretical load threshold of the overload mechanism. However, as explained before the load threshold may be misadjusted over time.

The pressure element 70 may exercise a gradual pressure against the upper frame 30 and the lower frame 20. This increase in pressure causes an increase in the traction on the traction wire 110 which is continuously monitored by the overload mechanism 170. The overload mechanism 170 triggers a warning signal when the traction on the traction wire 110 exceeds the load threshold of the overload mechanism 170.

In some examples, the overload mechanism 170 triggers a warning signal before reaching the predetermined load. The load threshold is thus lower than the predetermined load. The load threshold of the overload mechanism 170 may thus be adjusted. The load threshold may thus be increased. The overload mechanism may be adjusted to increase the load threshold until a warning signal is outputted by the overload mechanism 170 when the predetermined pressure is applied.

When the load threshold is lower than the predetermined load caused by the predetermined pressure, the method for setting the load threshold of the overload mechanism 170 may comprise increasing the load threshold until a warning signal is outputted by the overload mechanism 170 when the predetermined pressure is applied.

In some examples, the overload mechanism 170 may not trigger a warning signal when the predetermined load is applied. The load threshold is thus greater than the predetermined load. The overload mechanism 170 may thus be adjusted to reduce the load threshold. When the load threshold is greater than the predetermined load caused by the predetermined pressure, the method for setting the load threshold of the overload mechanism 170 may comprise reducing the load threshold until a warning signal is not outputted by the overload mechanism 170 when the predetermined pressure is applied.

The overload mechanism may be adjusted from outside the load carrier structure, e.g. from outside the lift cabin. A tool may be used for rotating the screw 175 so as to vary the elongation of the spring 174. The position of the overload switch may thus be regulated. Accordingly, the load threshold may be adjusted.

For reasons of completeness, various aspects of the present disclosure are set out in the following numbered clauses:

Clause 1: An overload testing system for testing an overload mechanism of a traction system of a lifting equipment, the overload testing system comprises:
a lower frame;
an upper frame configured to be coupled with a traction wire of the lifting equipment, wherein the upper frame is slidably connected to the lower frame;
a pressure element arranged between the upper frame and the lower frame to move the lower frame relative to the upper frame;
wherein the lower frame and the upper frame comprise a channel to receive the traction wire.

Clause 2: The overload testing system according to clause 1, further comprising a wire clamp for clamping the traction wire above the upper frame to prevent an upwards movement of the upper frame, wherein the wire clamp comprises:
a first clamp part;
a second clamp part, and
a connector to press the first clamp part and the second clamp part to each other to clamp the traction wire between the first clamp part and the second clamp part.

Clause 3: The overload testing system according to any of clauses 1-2, wherein the pressure element is configured to extend from an initial position to an extending position.

Clause 4: The overload testing system according to any of clauses 1-3, wherein the pressure element comprises a hydraulic cylinder.

Clause 5: The overload testing system according to clause 4, wherein the hydraulic cylinder extends from a lower end connected to the lower frame to an upper end connected to the upper frame.

Clause 6: The overload testing system according to clause 5, wherein a distance between the lower end and the upper end increases when a predetermined pressure is applied to the hydraulic cylinder.

Clause 7: The overload testing system according to any of clauses 4-6, wherein the pressure element is configured to be connected to a hydraulic pressure source.

Clause 8: The overload testing system according to any of clauses 1-7, further comprising:
an upper bushing configured to fit the channel of the upper frame and to receive the traction wire; and/or
a lower bushing configured to fit the channel of the lower frame and to receive the traction wire.

Clause 9: The overload testing system according to clause 8, wherein the upper bushing and/or the lower bushing comprises a first bushing part and a second bushing part to surround the traction wire.

Clause 10: the overload testing system according to any of clauses 8-9, wherein the upper bushing comprises:
an insertion portion comprising an outer diameter smaller than the diameter of the channel of the upper frame so that the insertion portion is configured to be inserted in the channel; and
a stopper portion comprising an outer diameter greater than the diameter of the channel of the upper frame so as to stop the insertion of the stopper portion into the channel.

Clause 11: The overload testing system according to any of clauses 8-10, wherein the upper bushing comprises an engaging portion to engage a wire clamp.

Clause 12: The overload testing system according to any of clauses 8-11, wherein the lower bushing comprises:
an insertion portion comprising an outer diameter smaller than the diameter of the channel of the lower frame so that the insertion portion is configured to be inserted into the channel; and
a stopper portion comprising an outer diameter greater than the diameter of the channel of the lower frame so as to stop the insertion of the stopper portion into the channel.

Clause 13: The overload testing system according to any of clauses 8-12, wherein the lower bushing comprises an engaging portion to engage the traction system.

Clause 14: The overload testing system according to any of clauses 1-13, wherein the lower frame comprises:
a base comprising the channel;
a first side wall perpendicular extending from the base; and
a second side wall perpendicular extending from the base.

Clause 15: the overload testing system according to clause 14, wherein the upper frame comprises:
a base comprising the channel;
a first side wall perpendicular extending from the base; and
a second side wall perpendicular extending from the base;
wherein the first side wall and the second side wall extend towards the base of the lower frame.

Clause 16: The overload testing system according to clause 15, wherein the pressure element is arranged between the side walls of the upper frame and of the lower frame.

Clause 17: The overload testing system according to any of clauses 15-16, wherein the side walls of the upper frame are arranged between the side walls of the lower frame.

Clause 18: The overload testing system according to any of clauses 15-17, wherein the side walls of the lower frame comprise a slot.

Clause 19: The overload testing system according to clause 18, further comprising:
a first connection assembly rotatably connected to the first wall of the upper frame and slidably connected to the first wall of the lower frame through the slot; and
a second connection assembly rotatably connected to the second side wall of the upper frame and slidably connected to the second side wall of the lower frame through the slot.

Clause 20: A method for testing an overload mechanism of a traction system of a lifting equipment, wherein the lifting equipment comprises:
an load carrier structure;
a traction wire; and
a traction system arranged at the load carrier structure for driving the load carrier structure along a lift path by engaging the traction wire, wherein the traction system comprises an overload mechanism to prevent a movement of the load carrier structure if the load of the load carrier structure is greater than a load threshold;
the method comprising:
positioning a lower frame of an overload testing system to rest on the traction system;
coupling an upper frame of the overload testing system with the traction wire, wherein the lower frame is slidably connected to the upper frame; and
applying a predetermined pressure to move the lower frame relative to the upper frame so as to increase a traction exercised on the traction wire.

Clause 21: The method according to clause 20, wherein positioning the lower frame to rest on the traction system comprises placing a lower bushing to rest on the traction system and inserting the traction wire into the lower bushing.

Clause 22: The method according to clause 21, wherein inserting the traction wire into the lower bushing comprises placing a first bushing part and a second bushing part around the traction wire.

Clause 23: The method according to any of clauses 21-22, wherein positioning the lower frame to rest on the traction system comprises inserting the lower bushing into a channel of the lower frame.

Clause 24: The method according to any of clauses 20-23, wherein coupling the upper frame with the traction wire comprises placing an upper bushing above the upper frame and inserting the traction wire into the upper bushing.

Clause 25: The method according to clause 24, wherein inserting the traction wire into the upper bushing comprises placing a first bushing part and a second bushing part around the traction wire.

Clause 26: The method according to any of clauses 24-25, wherein coupling the upper frame with the traction wire comprises inserting the upper bushing into a channel of the upper frame.

Clause 27: The method according to any of clauses 24-26, wherein coupling the upper frame with the traction wire comprises placing a wire clamp to rest on the upper bushing and clamping the traction wire with the wire clamp to prevent an upwards movement of the upper frame.

Clause 28: The method according to any of clauses 20-27, wherein the pressure element is a hydraulic cylinder, and wherein the method comprises connecting the hydraulic cylinder to a hydraulic pressure source.

Clause 29: The method according to clause 28, wherein applying the predetermined pressure comprises activating the hydraulic pressure source to provide the predetermined pressure to the hydraulic cylinder.

Clause 30: A method for setting a load threshold of an overload mechanism of a traction system of a lifting equipment, wherein the lifting equipment comprises:
a load carrier structure;
a traction wire; and
a traction system arranged at the load carrier structure for driving the load carrier structure along a lift path by engaging the traction wire, wherein the traction system comprises an overload mechanism to prevent a movement of the load carrier structure if the load of the load carrier structure is greater than a load threshold;
the method comprising:
testing the overload mechanism according to any of clauses 20-29;
adjusting the overload mechanism to set the load threshold corresponding to the predetermined pressure applied to the overload testing system.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. An overload testing system for testing an overload mechanism of a traction system of a lifting equipment, the overload testing system comprises:
a lower frame;
an upper frame configured to be coupled with a traction wire of the lifting equipment, wherein the upper frame is slidably connected to the lower frame; and
a pressure element arranged between the upper frame and the lower frame to move the lower frame relative to the upper frame;
wherein the lower frame and the upper frame comprise a lower channel and an upper channel, respectively, to receive the traction wire, so that the traction wire runs along the upper channel and the lower channel.

2. The overload testing system according to claim 1, further comprising a wire clamp for clamping the traction wire above the upper frame to prevent an upwards movement of the upper frame, wherein the wire clamp comprises:
a first clamp part;
a second clamp part, and
a connector to press the first clamp part and the second clamp part to each other to clamp the traction wire between the first clamp part and the second clamp part.

3. The overload testing system according to claim 1, wherein the pressure element is configured to extend from an initial position to an extending position.

4. The overload testing system according to claim 1, wherein the pressure element comprises a hydraulic cylinder.

5. The overload testing system according to claim 1, further comprising:
an upper bushing configured to fit the upper channel of the upper frame and to receive the traction wire; and/or
a lower bushing configured to fit the lower channel of the lower frame and to receive the traction wire.

6. The overload testing system according to claim 5, wherein the upper bushing and/or the lower bushing comprises a first bushing part and a second bushing part to surround the traction wire.

7. A method for testing an overload mechanism of a traction system of a lifting equipment, wherein the lifting equipment comprises:
a load carrier structure;
a traction wire; and
a traction system arranged at the load carrier structure for driving the load carrier structure along a lift path by engaging the traction wire, wherein the traction system comprises an overload mechanism to prevent a movement of the load carrier structure if a load of the load carrier structure is greater than a load threshold;
the method comprising:
positioning a lower frame of an overload testing system to rest on the traction system;
coupling an upper frame of the overload testing system with the traction wire, wherein the lower frame is slidably connected to the upper frame, wherein the lower frame and the upper frame comprise a lower channel and an upper channel, respectively, to receive the traction wire, so that the traction wire runs along the upper channel and the lower channel; and
applying a predetermined pressure to move the lower frame relative to the upper frame so as to increase a traction exercised on the traction wire.

8. The method according to claim 7, wherein positioning the lower frame to rest on the traction system comprises placing a lower bushing to rest on the traction system and inserting the traction wire into the lower bushing.

9. The method according to claim 8, wherein inserting the traction wire into the lower bushing comprises placing a first bushing part and a second bushing part around the traction wire.

10. The method according to claim 9, wherein positioning the lower frame to rest on the traction system comprises inserting the lower bushing into the lower channel of the lower frame.

11. The method according to claim 10, wherein coupling the upper frame with the traction wire comprises placing an upper bushing above the upper frame and inserting the traction wire into the upper bushing.

12. The method according to claim 11, wherein inserting the traction wire into the upper bushing comprises placing a first bushing part and a second bushing part around the traction wire.

13. The method according to claim 12, wherein coupling the upper frame with the traction wire comprises inserting the upper bushing into the upper channel of the upper frame.

14. The method according to claim 13, wherein coupling the upper frame with the traction wire comprises placing a wire clamp to rest on the upper bushing and clamping the traction wire with the wire clamp to prevent an upwards movement of the upper frame.

15. A method for setting a load threshold of an overload mechanism of a traction system of a lifting equipment, wherein the lifting equipment comprises:
a load carrier structure;
a traction wire; and
a traction system arranged at the load carrier structure for driving the load carrier structure along a lift path by engaging the traction wire, wherein the traction system comprises an overload mechanism to prevent a movement of the load carrier structure if a load of the load carrier structure is greater than a load threshold;
the method comprising:
positioning a lower frame of an overload testing system to rest on the traction system;
coupling an upper frame of the overload testing system with the traction wire,
wherein
the lower frame is slidably connected to the upper frame,
the lower frame and the upper frame comprise a lower channel and an upper channel, respectively, to receive the traction wire, so that the traction wire runs along the upper channel and the lower channel,
applying a predetermined pressure to move the lower frame relative to the upper frame so as to increase a traction exercised on the traction wire, and
adjusting the overload mechanism to set the load threshold corresponding to the predetermined pressure applied to the overload testing system.

16. The overload testing system according to claim 4, wherein the hydraulic cylinder extends from a lower end connected to the lower frame to an upper end connected to the upper frame.

17. The overload testing system according to claim 5, wherein the upper bushing comprises:
an insertion portion comprising an outer diameter smaller than the diameter of the upper channel of the upper frame so that the insertion portion is configured to be inserted in the upper channel; and
a stopper portion comprising an outer diameter greater than the diameter of the upper channel of the upper frame so as to stop the insertion of the stopper portion into the upper channel.

18. The overload testing system according to claim 5, wherein the lower bushing comprises:
an insertion portion comprising an outer diameter smaller than the diameter of the lower channel of the lower frame so that the insertion portion is configured to be inserted into the lower channel; and
a stopper portion comprising an outer diameter greater than the diameter of the lower channel of the lower frame so as to stop the insertion of the stopper portion into the lower channel.

19. The overload testing system according to claim 1, wherein the lower frame is configured to be supported by the traction system.

20. The overload testing system according to claim 1, wherein the lower frame is configured to be supported by a load carrier structure of the lifting equipment.
